(19) United States
(12) Patent Application Publication
(10) Pub. No.: US 2022/0206851 A1
(43) Pub. Date: Jun. 30, 2022

(54) REGENERATIVE WORK-GROUPS

(71) Applicant: Advanced Micro Devices, Inc., Santa Clara, CA (US)

(72) Inventor: Alexandru Dutu, Bellevue, WA (US)

(73) Assignee: Advanced Micro Devices, Inc., Santa Clara, CA (US)

(21) Appl. No.: 17/138,819

(22) Filed: Dec. 30, 2020

(51) Int. Cl. G06F 9/50; G06F 9/48

(52) U.S. Cl. CPC G06F 9/5011; G06F 9/4881

(57) ABSTRACT

A method and processing apparatus are provided for executing a program. The processing apparatus comprises memory and a processor. The processor is configured to dispatch a parent work group of a program to be executed and execute a spawn work group instruction to enable a child work group of the parent work group to be executed. The processor is also configured to dispatch the child work group for execution when a sufficient amount of resources are determined to be available to execute the child work group and execute the child work group on one or more compute units. The spawn work group instruction comprises a pointer to a synchronization variable, and the processor is also configured to execute a join workgroup instruction which comprises the pointer to the synchronization variable in the spawn work group instruction.

### BACKGROUND

Computational demanding tasks typically implement parallel processing techniques in which the processing of instructions can be divided among different processors or processing elements to save time. Parallel processing operates on the principle that a larger task can be divided into smaller tasks to reduce the amount time used to obtain a solution or result.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a block diagram illustrating exemplary components of an example processing device, including a single work group dispatcher, in which one or more features of the disclosure can be implemented; and

FIG. 4 is a block diagram illustrating exemplary components of an example processing device, including a single work group dispatcher, in which one or more features of the disclosure can be implemented.

FIG. 5 is a flow diagram illustrating an example processing method according to features of the disclosure

### DETAILED DESCRIPTION

Some algorithms, such as algorithms which include hierarchical data structures (i.e., adaptive grids), recursive algorithms and algorithms divided into independent batches, include nested or fork-join parallelism during processing, in which execution, of a portion (e.g., thread) of a program, forks (i.e., branches off) into sub-portions that are executed in parallel. When execution of the sub-portions is completed, the sub-portions join (merge) the portion of the program.

Conventional processing techniques and devices (e.g., GPUs) have been designed to mitigate issues, such as load imbalance in graphics applications for specific stages of the graphics pipeline, such as tessellation, geometry shaders and schedule draw. These conventional processing techniques and devices are not, however, designed to mitigate load imbalance associated with other types of applications (non-graphics applications) and are inefficient at fine granularities (e.g., work-items granularities and wavefront granularities). In addition, conventional processing techniques impose strict limits on the depth of parallelism nesting and incur kernel dispatch latency at coarse granularities (e.g., unnecessarily increasing the dispatch latency of a child kernel when the parent kernel is context switched).

For example, conventional accelerated processors (e.g., GPU) typically include a hierarchical execution model to provide independent forward progress for some execution abstractions (i.e., work-items, wavefronts, and kernels). Independent forward progress is provided when different execution abstractions can synchronize without deadlocking. The hierarchical execution priority, in descending order, for a GPU includes higher priority kernels, lower priority kernels, work groups, wavefronts, and work-items. For execution of such algorithms facilitated by nested parallelism, these conventional accelerated processors are not able to efficiently make independent forward progress when workgroups are synchronizing because nested parallelism is executed at the kernel granularity level (e.g., a kernel spawns another kernel).

Features of the present disclosure provide devices and methods of using nested parallelism, at the work-group level, to provide efficient processing of different types of application. Features of the present disclosure and utilize the benefit of hardware support for low latency dispatching of tasks. Features of the present disclosure provide an improved nested parallelism framework to efficiently execute both graphics and compute kernels by implementing fork-join parallelism at the work-group level, using virtualized work-group spawning through a work-group context stack and providing a hardware load-balancing for newly spawned work-groups.

Features of the present disclosure adhere to the hierarchical execution models of accelerated processors (e.g., GPUs) by utilizing a work group (multi work-items) dispatcher to dispatch work groups when kernels are being enqueued and enabling the work group dispatcher to dispatch spawned child work groups when a spawn work group instruction is executed by the parent work group and resources are available.

A processing method is provided which comprises dispatching a parent work group of a program to be executed, executing a spawn work group instruction to enable a child work group of the parent work group to be executed, dispatching the child work group for execution when a sufficient amount of resources are available to execute the child work group and executing the child work group.

A processing apparatus is provided which comprises memory and a processor. The processor is configured to dispatch a parent work group of a program to be executed, execute a spawn work group instruction to enable a child work group of the parent work group to be executed, dispatch the child work group for execution when a sufficient amount of resources are available to execute the child work group and execute the child work group on a compute unit.

A non-transitory computer readable medium is provided which comprises instructions for causing a computer to execute a processing method comprising dispatching a parent work group of a program to be executed, executing a spawn work group instruction to enable a child work group of the parent work group to be executed, dispatching the child work group for execution when a sufficient amount of resources are available to execute the child work group and executing the child work group.

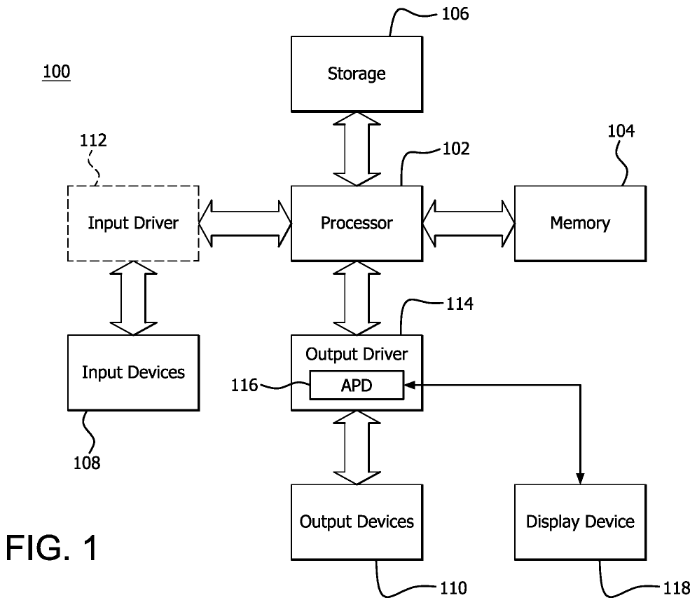

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

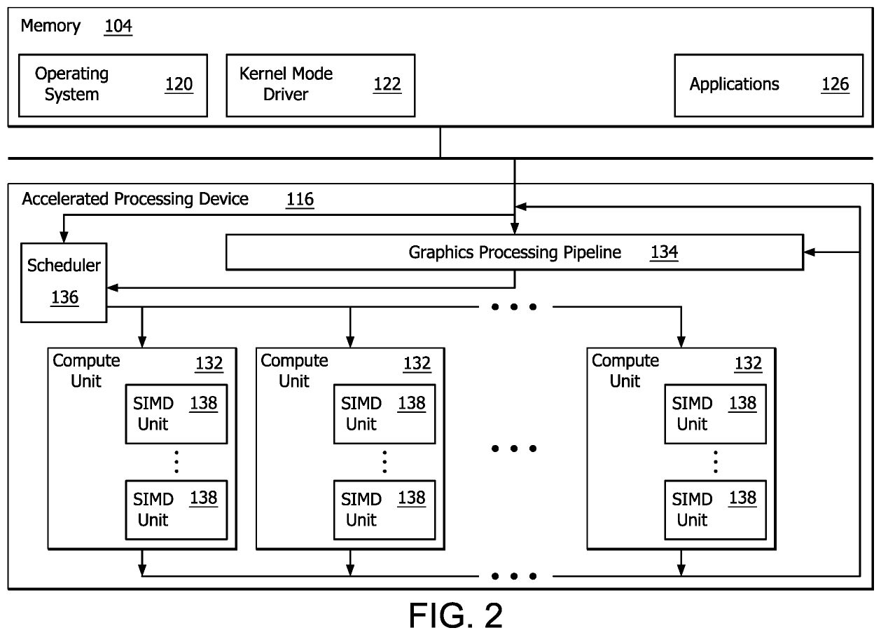

FIG. 2 is a block diagram of the device 100, illustrating additional details related to execution of processing tasks on the APD 116, such as processing tasks using nested parallelism, at the work-group level, as described in more detail herein. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed).

The APD 116 also includes a scheduler 136. As described in more detail below, the scheduler 136 performs operations related to scheduling various workgroups on different compute units 132 and SIMD units 138 and spawning and joining new work groups (e.g., child work groups of a parent work group) based on determined available resources. The scheduler 136, is for example, a single scheduler for scheduling (i.e., dispatching) parent and child work groups (i.e., a plurality of work-items or threads) on different compute units 132. Alternatively, the scheduler 136 includes a plurality of schedulers which schedule various work groups for execution on compute units 132.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

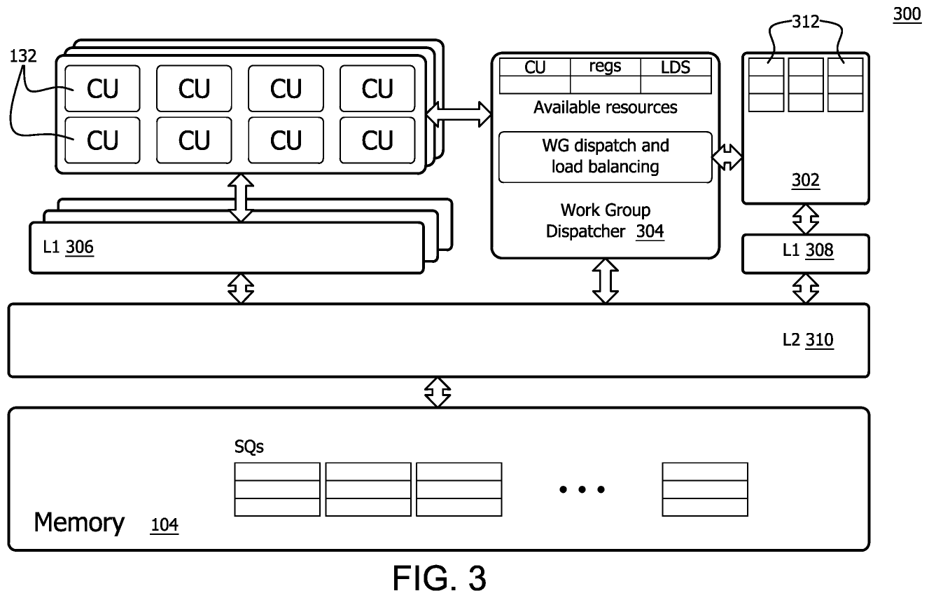

FIG. 3 is a block diagram illustrating exemplary components of an example processing device 300 in which one or more features of the disclosure can be implemented. As shown in FIG. 3, the processing device 300 includes a plurality of compute units (CUs) 132, processor 302, work group dispatcher 304, level 1 (L1) caches 306 and 308, level 2 (L2) cache 310 and memory 104.

Processor 302 is for example, a CPU, comprising multiple processor cores 312. Processor 302 is configured to implement various functions as described in detail herein. For example, processor 302 communicates with the work group dispatcher to determine whether there are available resources to launch a new program (e.g., kernel). Available resource include, for example, a compute unit and work group context memory (e.g., registers such as scalar registers, vector registers and machine specific registers as well as LDS memory on a GPU chip) accessed by work-items within a workgroup. Compute units 132 can utilize different portions of memory (e.g., L1 cache 306, L2 cache 310 and memory 104). In addition to launching programs (e.g., kernels) for execution on compute units 132, processor 302 also executes instructions utilizing L1 cache 308, L2 cache 310 and memory 104).

The work group dispatcher 304 is, for example, implemented in hardware (e.g., fixed function hardware), software or a combination of hardware and software. Processor 302 is configured to control dispatcher 304 to dispatch work groups (e.g., a plurality of work-items) for execution on the compute units 132 and perform load balancing based on available compute unit resources, available work group context memory, locality between parent and child work groups. Work group dispatcher 304 executes spawn work group instructions and join work group instructions, as described in detail herein. Work group dispatcher 304 can spawn work groups as the spawn instructions, using the previously provided address for the kernel object and the work group dimensions. Additionally, kernel arguments are passed from the parent to the child kernel through an argument passing stack. For example, the compiler can generate instructions to perform argument passing. The work group dispatcher 304 can also inspect the argument passing stacks of both parent and child work groups to infer if the child work group accesses the same addresses as the parent work group and to which compute unit the child work group is to be dispatched.

Additionally, in the case of irregular applications, work groups from a limited number (e.g., one) of compute units spawn new work groups (e.g., work groups executing on different compute units have previously finished execution). In this case, work group dispatcher 304 dispatches newly spawned work groups to compute units different from the compute units executing their corresponding parent work groups, to increase utilization of hardware resources.

Processor 302 allocates memory for work group context switching and argument passing (e.g., executes operating system-like services for memory allocation). Additionally or alternatively, the processor 102 relies on a driver to pre-allocate memory for a threshold number of work-groups for a kernel. For example, when a number of work-groups is equal to or greater than the threshold number of work-groups (e.g., because the number of work groups cannot be determined through a static analysis of the compiler), the processor 302 requests the driver to allocate more work group context memory.

Memory 104 is, for example, main memory, which is located on the same chip with the processor 302, located on a different chip than the processor 302, stacked in a separate die, located on top of the processor 302 (e.g., same chip but different level), or located on the same chip but on a different die.

The example processing device 300 shown in FIG. 3, includes a single work group dispatcher 304 for dispatching work groups (e.g., a plurality of work-items) for execution on the compute units 132. Alternatively, features of the disclosure can be implemented using multiple work group dispatchers for dispatching work groups for execution on the compute units 132.

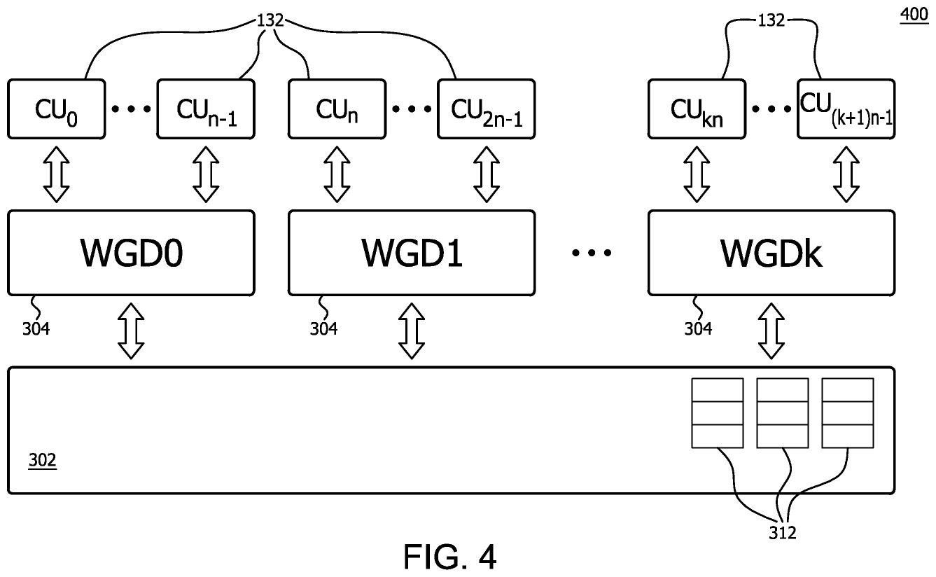

FIG. 4 is a block diagram illustrating exemplary components of an example processing device 400, including multiple work group dispatchers 304, in which one or more features of the disclosure can be implemented.

As shown in FIG. 4, processing device 400 includes k number of work group dispatchers 304. Each work group dispatcher (WGD0, WGD1 . . . WGDk) executes work groups utilizing a different group of compute units 132. As shown in FIG. 4, work group dispatcher WGD0 utilizes compute units CU₀ . . . CUₙ₋₁, work group dispatcher WGD1 utilizes compute units CUₙ . . . CU2ₙ₋₁ and work group dispatcher WGDk utilizes compute units CUkₙ . . . CU CU₍ₖ₊₁₎ₙ₋₁. Feature of the disclosure can be implemented using any number of work group dispatchers. In addition, a group of compute units 132, allocated to a work group dispatcher 304, can include any number of compute units 132. Additionally, when multiple dispatchers are used, one dispatcher can pass spawn instructions to a different dispatcher when each of its compute units have no resources available to spawn a new work group.

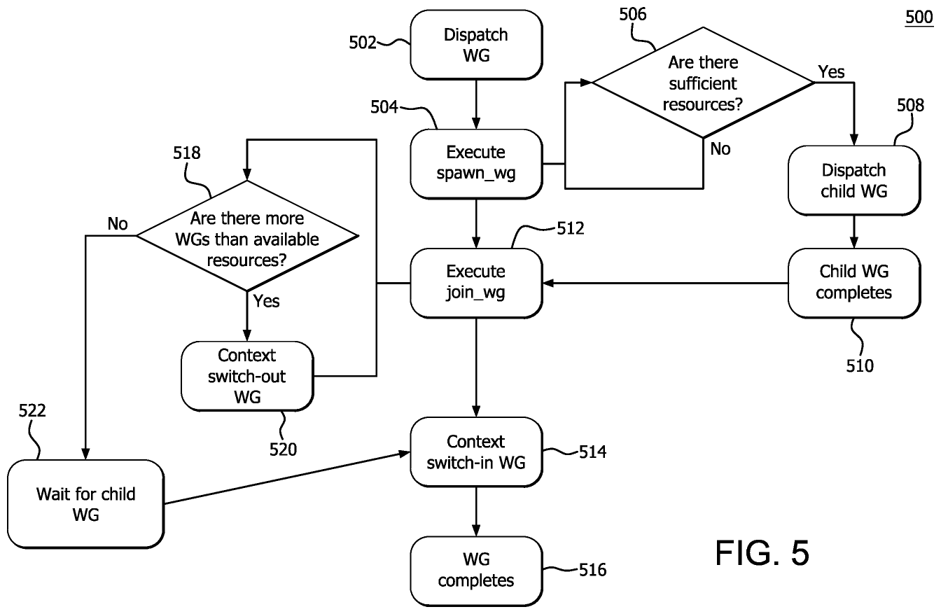

FIG. 5 is a flow diagram 500 illustrating an example processing method 500 according to features of the disclosure. In the example processing method 500 shown in FIG. 5, a join instruction is used to implement context switching.

As shown at block 502 of FIG. 5, the method 500 includes dispatching a work group (WG) for execution on one or more processing elements (e.g., compute units). For example, during execution of a program, one of the compute units 132 requests a new work group by executing an instruction (e.g., spawn_wg), at block 504, which enables one or more child work groups to be dispatched for execution by dispatcher 304.

An example of the opcode for the spawn workgroup instruction (e.g., spawn_wg) is shown below.

| | | | |
|---|---|---|---|
| OP (7) | KADDR (8) | DIMS (8) | SYNCV (8) |

The example spawn workgroup instruction includes 3 source operands: an 8 byte KADDR operand which specifies a pointer to the kernel; an 8 byte DIMS operand which specifies the dimensions of the work group; and an 8 byte SYNCV operand which is the pointer to a synchronization variable used to join the work group. The number of bytes shown for the operands in the spawn workgroup instruction is merely an example. Each operand of a spawn workgroup instruction can include a number of bytes different than the number of bytes shown in the example spawn workgroup instruction.

A join instruction is also executed at block 512. An example of the opcode for the join workgroup instruction (e.g., join_wg) is shown below.

| | |
|---|---|
| OP (7) | SYNCV (8) |

As shown, the example join workgroup instruction includes the 8 byte SYNCV operand which is the pointer to the synchronization variable used to join the work group. The number of bytes for the operands shown in the join workgroup instruction is merely an example. Each operand of a join workgroup instruction can include a number of bytes different than the number of bytes shown in the example join workgroup instruction.

When the join work group instruction is used, the parent work group waits for the child work group to complete execution, using the join instruction which includes the source operand specifying the pointer to the synchronization variable and the parent work group is context switched out to allow the child kernel to begin execution.

Processor 302 allocates memory for work group context switching and argument passing (e.g., executes operating system-like services for memory allocation). Additionally or alternatively, the processor 102 relies on the driver 122 to pre-allocate memory for a threshold number of regenerative work-groups for a kernel. For example, when a number of regenerative work-groups threshold is equal to or greater than the threshold number of regenerative work-groups (e.g., because the number of regenerative work-groups cannot be determined through a static analysis of the compiler), the processor 302 requests the driver (e.g., kernel mode driver 122 shown in FIG. 2) to allocate more work group context memory.

When the spawn work group instruction is executed at block 504, the method proceeds to decision block 506 to determine whether or not there are sufficient resources available for executing a child work group. For example, it is determined (e.g., via fixed function hardware) whether there are sufficient compute units and work group context memory (e.g., registers such as scalar registers, vector registers and machine specific registers as well as LDS memory on a GPU chip) is allocated (e.g., by the processor issuing the work group instruction) available to execute a child work group.

When it is determined, at decision block 506, that there are not sufficient resources available (e.g., not enough allocated local or global memory) to execute a child work group (e.g., because the allocated memory is currently being used to execute other child work groups), the method proceeds back to decision block 506 until there are sufficient resources available to execute the child work group. For example, when it is determined, at decision block 506, that there are not sufficient resources available, resources are freed up by executing a join_wg instruction. When it is determined, at decision block 506, that there are sufficient resources available for executing a child work group, the child work group is dispatched at block 508.

As described above, when the join work group instruction is executed at block 512, the parent work group waits for the child work group to complete execution and the parent work-group is context switched out to allow the child work group to execute. When the child work group completes execution, at block 510, the method proceeds back to block 512. The source operand specifying the pointer to the synchronization variable is used to determine that the child work group completes execution and the parent work group is context switched back in at block 514 to finish executing. The parent work group then completes execution at block 516.

In addition, when the join work group instruction is executed at block 512 and while the parent work group waits for the child work group to complete execution, the method proceeds to decision block 518 to determine whether or not there are more work groups to be dispatched than available resources (e.g., memory, registers, and compute units) to execute the work groups. That is, it is determined whether or not a sufficient amount resources (e.g., compute unit and work group context memory) are available to execute the plurality of work groups).

When it is determined, at block 518, that there are more work groups to be dispatched than available resources (Yes decision), the parent work group is context switched out, at block 520, execution of the parent work group stops and the method proceeds back to decision block 518 to again determine whether or not there are more work groups to be dispatched than available resources. If memory is pre-allocated for a threshold number of work-groups for a kernel and the number of work-groups threshold is equal to or greater than the threshold number of work-groups, a request (e.g., by processor 302 to the driver) is made to allocate additional work group context memory.

When it is determined, at block 518, that there are not more work groups to be dispatched than available resources (No decision), the parent work group waits for the child work group to be completed at block 522. When the child work-group completes (e.g., an indication is provided using the synchronization variable specified by the join_wg instruction), the parent work group is context switched back in, at block 514, to finish executing.

Workgroup context switching is implemented in hardware, software or a combination of hardware and software. For example, workgroup context switching is implemented in hardware when the join work group instruction is used. Additional or alternatively, workgroup context switching is implemented in software by having the compiler generate save/restore instructions for the live registers at join_wg. Multiple hardware synchronization mechanisms can be used between child and parent work-groups, including using waiting atomic operations. The spawn work group instruction and the join work group instruction can also be implemented as vector or scalar instructions depending on dispatch granularity.

When each of the parent work groups and spawned child work groups have completed execution, the processor writes to the synchronization variable specified by the spawn_wg instruction. Accordingly, the parent work groups wait for each spawned work group to finish their execution by using the join_wg instruction. The join_wg instruction is used to detect the writes to the synchronization variable and allow the parent work group to resume execution when each of the child work groups have written to the synchronization variable.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, 302, the input driver 112, the input devices 108, the output driver 114, the output devices 110, the accelerated processing device 116, the scheduler 136, the graphics processing pipeline 134, the compute units 132, the SIMD units 138, and work group dispatcher 304 may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A processing method comprising:
dispatching a parent work group of a program to be executed;
executing a spawn work group instruction to enable a child work group of the parent work group to be executed;
dispatching the child work group for execution when a sufficient amount of resources are determined to be available to execute the child work group; and
executing the child work group.

2. The method of claim 1, further comprising
determining whether or not the sufficient amount of resources are available to execute the child work group prior to dispatching the child work group for execution on a compute unit; and
when the sufficient amount of resources are determined to be unavailable to execute the child work group, waiting until the sufficient amount of resources are available to dispatch the child work group for execution on the compute unit.

3. The method of claim 2, wherein determining whether or not the sufficient amount of resources are available to execute the child work group comprises determining whether or not the compute unit and work group context memory, to be accessed by work-items of the child work group, are available.

4. The method of claim 3, wherein the work group context memory comprises at least one of registers and local data store (LDS) memory.

5. The method of claim 1, wherein the spawn work group instruction comprises a pointer to a synchronization variable, and
further comprising executing a join workgroup instruction which comprises the pointer to the synchronization variable in the spawn work group instruction.

6. The method of claim 5, further comprising:
determining completion of execution of the child work group by using the pointer to the synchronization variable;
context switching-in the parent work group when the child work group completes execution; and
executing the parent work group.

7. The method of claim 1, wherein the resources are allocated by a processor which dispatches the parent work group and the child work group for execution.

8. The method of claim 1, wherein the program is a kernel and an amount of resources are allocated to execute a plurality of work groups for the kernel, and
the method further comprises:
executing the parent work group;
when a sufficient amount resources is determined to be available to execute the plurality of work groups, continuing execution of the parent work group; and
when the sufficient amount resources is determined not to be available to execute the a plurality of work groups, context switching-out the parent work group.

9. The method of claim 8, wherein an amount of memory is allocated for a threshold number of work groups for the kernel, and
the method further comprises:
determining whether a number of work groups currently executing for the kernel is less than the threshold number of work groups;
when the number of work groups currently executing for the kernel is less than or equal to the threshold number of work groups, continuing execution of the child work group; and
when the number of work groups currently executing for the kernel is greater than the threshold number of work groups, allocating additional memory.

10. A processing apparatus comprising:
memory; and
a processor configured to:
dispatch a parent work group of a program to be executed;
execute a spawn work group instruction to enable a child work group of the parent work group to be executed;
dispatch the child work group for execution when a sufficient amount of resources are determined to be available to execute the child work group; and
execute the child work group on a compute unit.

11. The processing apparatus of claim 10, wherein the processor is configured to:
determine whether or not the sufficient amount of resources are available to execute the child work group prior to dispatching the child work group for execution on the compute unit; and
when it is determined that the sufficient amount of resources are available to execute the child work group, waiting until the sufficient amount of resources are available to dispatch the child work group for execution on the compute unit.

12. The processing apparatus of claim 11, wherein the memory comprises work group context memory to be accessed by work-items, and
the processor is configured to determine whether or not the sufficient amount of resources are available to execute the child work group by determining whether or not the compute unit and work group context memory, to be accessed by work-items of the child work group, are available.

13. The processing apparatus of claim 12, wherein the work group context memory comprises at least one of registers and local data store (LDS) memory.

14. The processing apparatus of claim 10, wherein the spawn work group instruction comprises a pointer to a synchronization variable, and
the processor is configured to execute a join workgroup instruction which comprises the pointer to the synchronization variable in the spawn work group instruction.

15. The processing apparatus of claim 14, wherein the processor is configured to:
determining completion of the execution of the child work group by using the pointer to the synchronization variable;
context switching-in the parent work group when the child work group completes execution; and
executing the parent work group.

16. The processing apparatus of claim 10, wherein the processor is configured to allocate an amount of resources for executing the child work group.

17. The processing apparatus of claim 10, wherein the program is a kernel and an amount of resources are allocated to execute a plurality of work groups for the kernel, and
the processor is configured to:
execute the parent work group;
when a sufficient amount resources is determined to be available to execute the plurality of work groups, continue execution of the parent work group; and
when the sufficient amount resources is determined not to be available to execute the a plurality of work groups, context switch-out the parent work group.

18. The processing apparatus of claim 17, wherein an amount of memory are allocated to execute a threshold number of work groups for the kernel, and
the processor is configured to:
determine whether a number of work groups currently executing for the kernel is less than the threshold number of work groups;
when the number of work groups currently executing for the kernel is less than or equal to the threshold number of work groups, continue execution of the child work group; and
when the number of work groups currently executing for the kernel is greater than the threshold number of work groups, allocate additional memory.

19. A non-transitory computer readable medium, comprising instructions for causing a computer to execute a processing method comprising:
dispatching a parent work group of a program to be executed;
executing a spawn work group instruction to enable a child work group of the parent work group to be executed;
dispatching the child work group for execution when a sufficient amount of resources are available to execute the child work group; and
executing the child work group.

20. The computer readable medium of claim 19, wherein the instructions comprise:
determining whether or not the sufficient amount of resources are available to execute the child work group prior to dispatching the child work group for execution on a compute unit; and
when the sufficient amount of resources are determined to be unavailable to execute the child work group, waiting until the sufficient amount of resources are available to dispatch the child work group for execution on the compute unit.
